(19) United States
(12) Patent Application Publication
(10) Pub. No.: US 2005/0091381 A1
(43) Pub. Date: Apr. 28, 2005

(54) Attribute based communication part 2

(76) Inventor: Nandan Sunder Rajan, Bangalore (IN)

Correspondence Address: Landon IP Inc, Suite 450, 1700 Diagonal Road, Alexandria, VA, 22314, US

(21) Appl. No.: 10/995,229

(22) Filed: Nov. 24, 2004

Related U.S. Application Data
(63) Continuation-in-part of application No. 10/809,063, filed on Mar. 24, 2004.
(60) Provisional application No. 60/457,439, filed on Mar. 26, 2003.
(60) Provisional application No. 60/525,185, filed on Nov. 28, 2003.

(51) Int. Cl. G06F 15/16; G06F 7/00; G06F 17/30; H04B 7/00

(52) U.S. Cl. 709/227; 707/10; 709/206; 370/310

(57) ABSTRACT

Attributes of a person such as biometrics information, associated vehicle number, relative location of residence are used to establish communication links rather than the network identifier of the communication unit possessed by the person.

This is a continuation-in-part application of pending application Ser. No. 10/809,063 entitled “Attribute Based Communication” filed on Mar. 24, 2004 by N. Rajan which claims priority benefit of provisional application Ser. No. 60/457,439 filed on Mar. 26, 2003 by the same inventor, and this application also claims the benefit of provisional application Ser. No. 60/525,185 which is entitled “Attribute Based Communication Part 2” and was filed on 28 Nov. 2003 by the same inventor, which prior applications are incorporated herein in their entireties by this reference thereto.

### BACKGROUND

1. Field of the Invention

The present invention relates generally to personal communications and more particularly to attribute based communications over existing networks.

2. Description of Related Art

The contents of this section are to be treated as in addition to contents disclosed in the corresponding section of the application Ser. No. 10/809,063.

The system needs to establish communication between initiator and recipient without either being aware of the others network identifier. This can be accomplished in the following ways:

FIG. 6.A shows the Connection setup method. In case the characteristic of the network permits, the recipient can be determined during connection setup and the connection directly established with recipient.

In such a case the initiator will send out a connection request to a specially designated virtual node on the network. The network will be aware that the particular node identifier is non-existent and that the actual node needs to be determined using information associated with the connection request. (Obviously, this method of connection setup can only be used where the network is capable of such functionality).

FIG. 6.B shows the Connection Forward method. Initially the initiator establishes a communication channel with the resolution center. The resolution center then determines the ultimate recipient based on the attribute information and then requests the network to re-route the communication with the intended recipient.

In order to protect privacy, during billing, the network can also be provided with the temporary identifiers used in communication—so that they appear during billing as opposed to the network identifiers.

FIG. 6.C shows the Bridge method: The capability of establishing communication between initiator and recipient without either being aware of the others network identifier can be accomplished by a using a communication bridge. In this mechanism two separate communication channels are established: one between initiator and the resolution center, the other between registration center and recipient. The resolution center acts as a communication bridge transferring data between the two channels.

In the telephone network, telephone conference equipment work on the principle of establishing a communication bridge between the participants.

On the internet chat servers act as a communication bridge between two chat participants transferring data back and forth between the participants behind-the-scenes.

Modes of specifying attribute information:

Since voice is the primary medium of communication for people, a small note is made here on voice communication. The technology discussed is in public domain and widely used.

Attribute based communication involves using any information to identify the destination node. Thus data (i.e. any information) is used to determine the recipient, although the communication between initiator and recipient may well be through voice.

The mechanisms available to setup connections with data are:

Data processing at connection setup: In networks where connection setup allows data to be provided as part of the connection setup protocol, this mechanism can be adopted. The initiator can be made to request for a connection to a virtual node, specifying the attribute information as part of the connection setup sequence. The network elements use the information to query a database, determine the destination node and then setup a connection.

Data processing after connecting: A connection is established with a designated node on the network. The data is then passed on this connection to the designated node. The node then queries a database to determine the best destination and then sets up a connection between the initiator and recipient.

Below two forms of such a system are touched upon:

Multi-stream networks: In networks such as H.323, where multiple data formats are supported the data can be sent along as data stream.

Data encoding: In networks where there is no explicit support for data, some form of data encoding can be used to pass on the data. For example, touch-tone based Interactive Voice Response (IVR) systems are one such mechanism on POTS network.

Connection and connectionless communication channels: In general communication networks provide two modes of communicating: connection oriented and connectionless. In connection-based communication two nodes setup a connection—this allows them to transmit data between the nodes. Usually this mode also provides for guaranteed delivery of data across the network. Also, some form of synchronization between the nodes and network elements may need to occur before a connection can be established. In connectionless communication, nodes communicate through messages. Message delivery may not be guaranteed. (Note that by adding an additional layer of functionality a guaranteed delivery mechanism can be built over a connectionless mechanism).

For connection-based communication, devices need to maintain a track of each connection and the corresponding temporary connection identifier. For connectionless communication, devices need to track communication identifiers that need to be used for every message being sent back and forth.

The Best mode embodiment is for attribute information to be provided as part of connection setup information. Whenever the network characteristics do not permit such operation a communication bridge is to be used. (This is different from bridge calls).

### SUMMARY OF THE INVENTION

In accordance with one illustrative embodiment of the present invention, there is provided a system that allows communications to occur on the basis of attributes such as biometrics information, location of residence, vehicle number of the vehicle associated with a person rather than just phone number or network identity on some other electronic communication system.

In addition, for ease of description, some terms are described below as they are used with respect to the embodiments described herein. To the extent that the definitions are narrower than the common use of the terms, they are applicable here only with respect to these embodiments and not intended to limit the scope of the claims.

Initiator: The user who initiates a conversation.

Recipient/destination node: The user/node who responds to a conversation initiated by someone else.

### BRIEF DESCRIPTION OF DRAWINGS

As a general matter, Identification numbers of drawings start from an offset so as to not interfere with drawing numbers specified in the application Ser. No. 10/809,063.

FIG. 6 describes the different kinds of connection setup for an attribute call system.

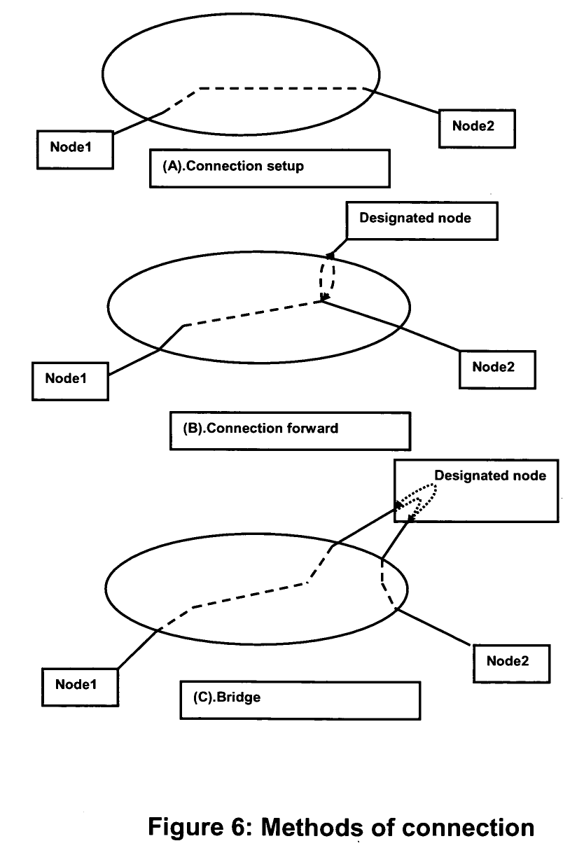

FIG. 7 shows the flow diagram for both connection and connectionless type for Registration center.

FIG. 8 shows the flow diagram for both connection and connectionless type for Resolution center.

FIG. 9 describes the flow chart for a Node.

FIG. 10 describes the flow chart for a query attributes operation on a Node.

FIG. 11 shows the flow chart for a Node to establish a conversation.

FIG. 12 is a system element and communication flow diagram for an SMS/MMS groups according to one embodiment of the present invention.

FIG. 13 is a system element and communication flow diagram for Biometrics communication according to one embodiment of the present invention.

FIG. 14 is a system element and communication flow diagram for neighborhood network according to one embodiment of the present invention.

FIG. 15 is a system element and communication flow diagram for Group owned communication identifiers according to one embodiment of the present invention.

FIG. 16 is a system element and communication flow diagram for Multiple profiles and multiple identities according to one embodiment of the present invention.

FIG. 17 is a system element and communication flow diagram for No-propagation group according to one embodiment of the present invention.

FIG. 18 is a system element and communication flow diagram for InfraRed based registration according to one embodiment of the present invention.

FIG. 19 is a system element and communication flow diagram for Device based resolution using Bluetooth according to one embodiment of the present invention.

FIG. 20 is a system element and communication flow diagram for Vehicle based communication according to one embodiment of the present invention.

FIG. 21 is a system element and communication flow diagram for Built-in directory based communication according to one embodiment of the present invention.

### DETAILED DESCRIPTION OF THE INVENTION

As a general matter, embodiments of the invention described below are based on descriptions of network components in the application Ser. No. 10/809,063. Like elements are reference with like numbers.

This application references a message called ‘Group_Attribute_resolve’. This message is the same as the ‘Port_Attribute_resolve’ message described in the application ser. No. A reference to this message in this document should be treated as a reference to the ‘Port_attribute_resolve’ message described in the application Ser. No. 10/809,063.

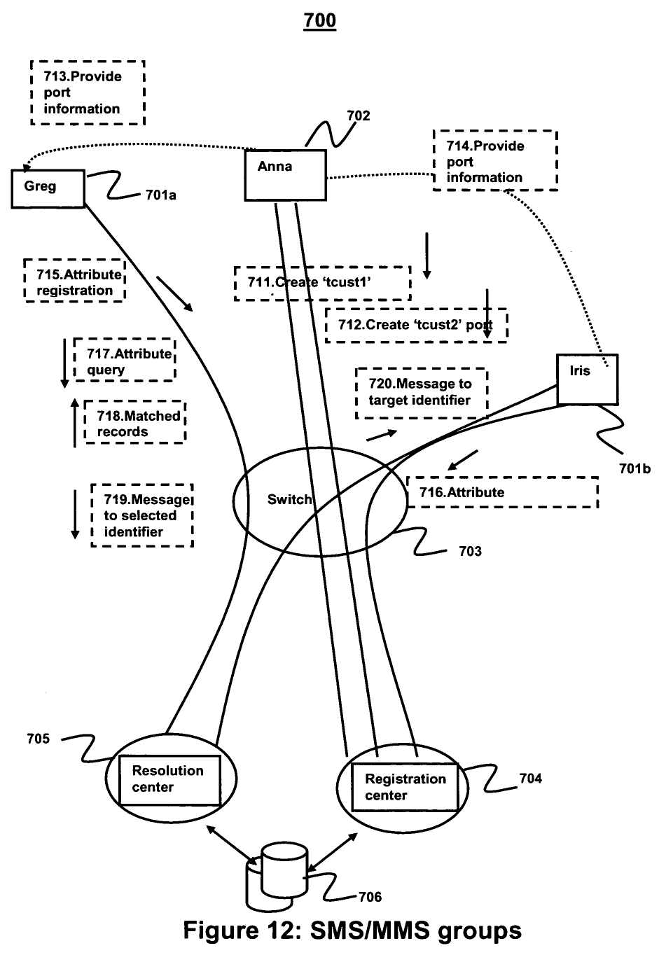

As a general matter, the Resolution Center (705) referred to in the figures (for example FIG. 12) performs attribute matching between identification attributes specified by a user as part of initiation communication setup and those registered in the registration database. The same functionality is provided as part of the SCP 110 described in the application Ser. No. 10/809,063.

On networks where connection is setup through a bridge, the resolution center will act as the bridge apart from performing attribute matching as before.

For ease of explanation, this component is now shown separately. So that the same figure can depict both connection setup and bridge methods of establishing connection. Our best mode embodiment is the connection setup approach and hence this component will form a part of the SCP as before. As a result no new explanations of its functioning are provided.

For description purposes, a set of sample phone numbers are used to describe the operation of the system according to one embodiment of the present invention. As a general matter, the area code “600” used in connection with this description is intended to represent a conventional virtual number prefix, e.g., 800, 877, or the like.

The message types, layouts and database tables are similar to those described with respect to the Group enabled embodiments in the application Ser. No. 10/809,063.

The following description pertaining to this section should be treated as in addition to the description in the corresponding section application Ser. No. 10/809,063.

The nature of this description is to provide additional information in terms of implementation of the system. Those of ordinary skill in the art will be able to implement embodiments of this invention without referring to the following description and may do so without departing from the principles of the claimed invention.

One implementation model is explained with the help of flowchart like diagrams.

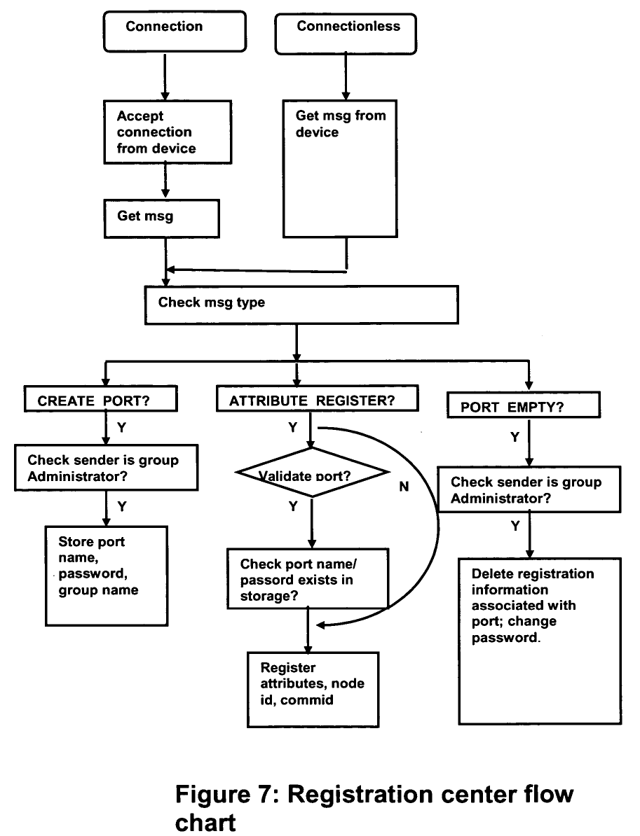

Now referring to FIG. 7, a Registration center implementation logic is described. The registration center performs the following tasks: (1). Registering attributes of users (2). Helping in group administration The registration center accepts and processes CREATE_PORT, PORT_ATTRIBUTE_REGISTER or PORT_EMPTY messages on connection/connectionless networks.

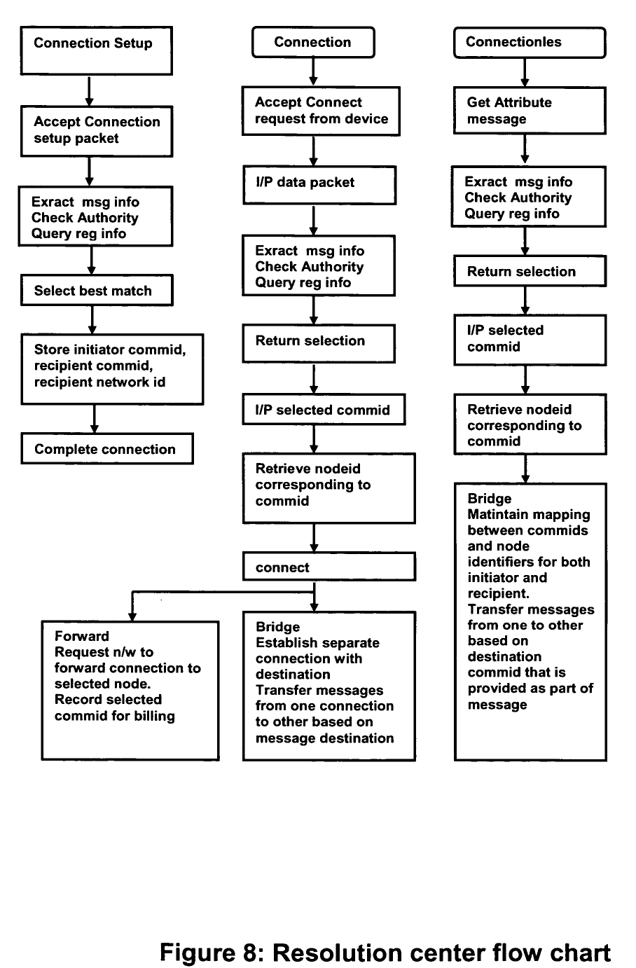

FIG. 8, describes an illustrative logic for a resolution center. The resolution center performs the following tasks: (1). Accept query information that is used to find destinations with matching/near matching attributes. (2). Based on the accepted information, used suitable algorithm to determine best matches. (3). Provide user with selected list so that she can make a selection OR Select best match (4). Setup connection with destination node identified in previous task (i.e. 3).

A few notes on the different steps:

Check authority: This step checks authority to send the message. In our implementation model, validation of the port information provided as part of the message accomplishes such authority checking.

The flow chart shows connection setup logic using three different methods: connection setup, connection and connectionless.

Connection setup: In this method the query information is provided as part of the connection setup sequence. Since the query information needs to be processed during connection setup, the registration center may take on the role of a specialized functional component that aids network elements (such as switches, routers) in completing the connection.

Again, since the processing takes place during connection setup, the current flow shows a best match being determined automatically, without providing the user an opportunity to make a selection. (This can be changed to accommodate user selection, but is omitted here for the sake of ease of explanation).

Connection: In connection method, a connection is setup with the registration center and then the query information is obtained. (This could be using one of the methods discussed in section 4.5).

In establishing the connection, two methods are shown: forward and bridge. Either one can be employed depending on network characteristics.

Connectionless: In this method no connection is setup between initiator and resolution center. Hence a bridge is used that transfers messages between one node and the other.

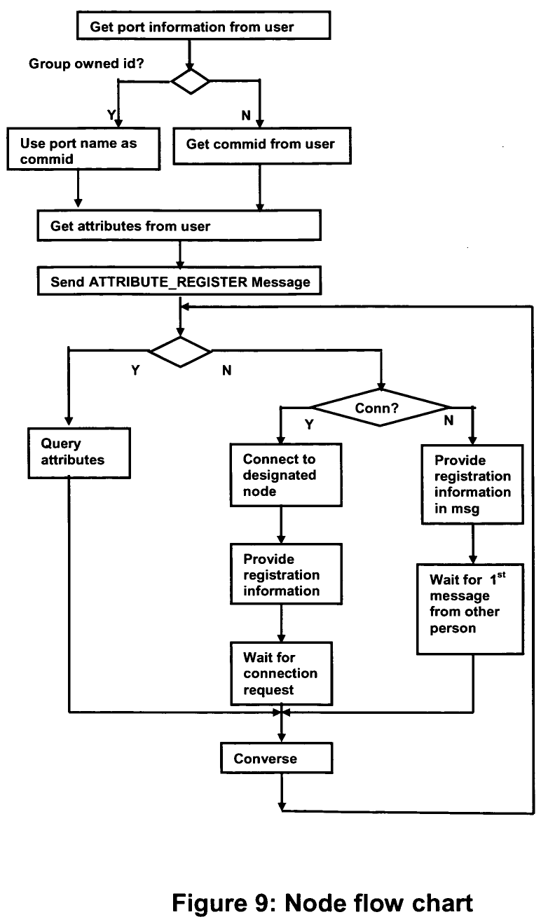

FIGS. 9,10,11 show illustrative logic for implementation on the Node. As can be seen from the figures, the node picks up attributes, communication identifier, port information from the user and then registers this information in the registration center.

In this implementation, for groups that own communication identifiers, the port name doubles as the communication identifier. Once attributes are registered the device prompts user to decide whether: to wait for someone to contact it OR to attempt contacting someone by querying for attributes. Either way a conversation is established and the logic then loops back to prompting the user again.

Note that in practice it is possible to do both simultaneously. The depiction here is for simplifying the figure.

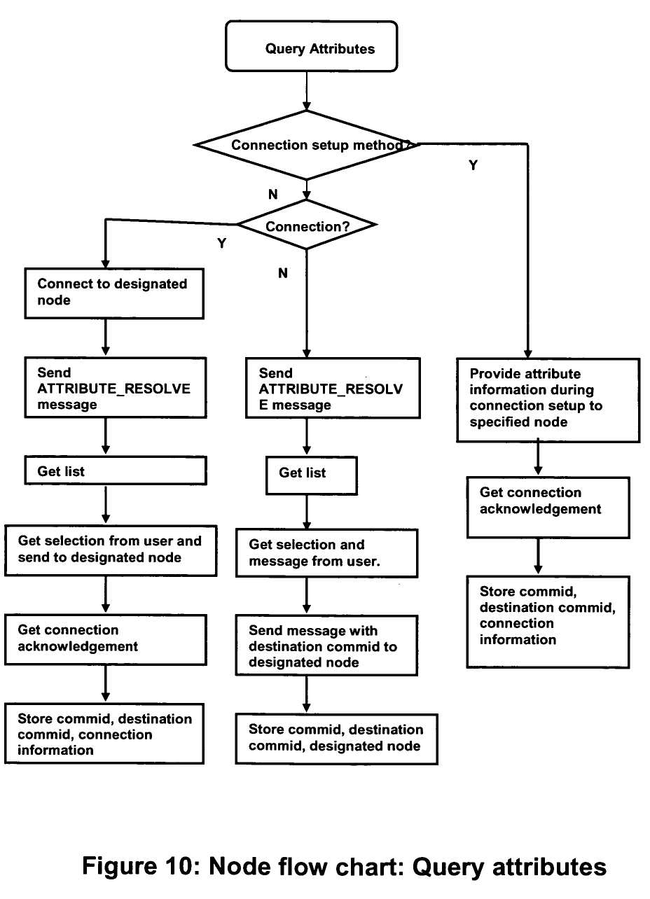

FIG. 10 depicts an illustrative logic flow in the Node for different methods of querying for attributes and establishing connection.

In the ‘Get List’ step, a list of one or more best matches is returned by the resolution center. This can be in the form of voice menu played to the user or a data packet.

In the case of connectionless protocols, once the user selects the desired communication identifier, the first message can be sent out since no connection establishment is required. As a result, the flowchart shows the same logic.

The ‘Get connection acknowledgement’ refers to obtaining an indication from the network that connection has been established with destination. This could be a specific message that is defined as part of the connection protocol.

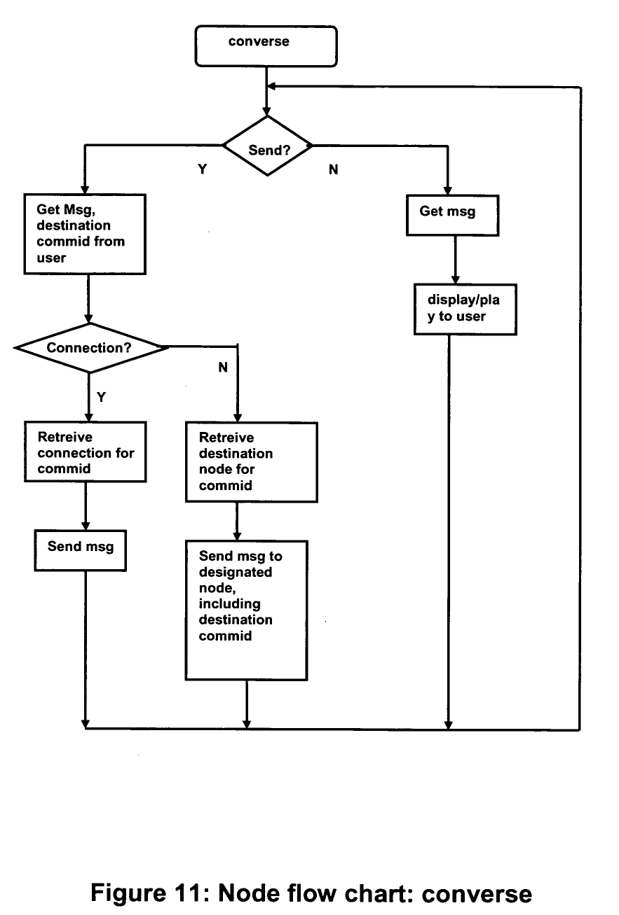

FIG. 11 shows the logic for carrying on a conversation. Essentially a conversation is a sequence of messages exchanged by the participants. Thus the logic shows user deciding to either send or receive a message in a loop.

The ‘Send’ step, is depicted in the ‘yes’ branch of the ‘Send’ decision box. For connection-based protocols, the destination communication identity just needs to be mapped to the correct connection and then the message can be sent across. For connectionless protocols, the node designated to handle that particular destination communication identity needs to be determined and then the message can be dispatched. As pointed out in the flowchart, the destination communication identity needs to be a part of the message—so that the designated node can figure out who is the ultimate recipient of the message and pass it on.

The ‘Receive’ step is depicted in the ‘No’ branch of the ‘Send’ decision box. The receive operation is simple: just retrieve the message and then display/play the message.

### Illustrative Embodiment of SMS/MMS Local Groups

This embodiment of the present invention is like the real-time networking embodiment described in the application Ser. No. 10/809,063.

In this embodiment, two exemplary users are used to illustrate communication using short message service/multi-media message service in a physical location controlled by an administrator.

The message types, layouts and database tables are similar to those described with respect to the Group enabled embodiments.

### System Operation

Table 12 describes one embodiment of system 700 as shown in FIG. 12. For illustration purposes, corresponding examples to each of the steps relate to a sample transaction. In this example, a amusement park decides to avail of the “spot grouping” service. The management of the park identifies Anna to be the group administrator.

TABLE 12

| Step | Description | Example |
|---|---|---|
| 711, 712 | Communication ports | Anna (702) the group administrator |
| | are created | creates two ports ‘cust1’ and |
| | | ‘cust2’ by sending PORT_CREATE |
| | | messages |
| 713, 714 | Port information is | Greg (701a) and Iris (701b) arrive |
| | provided to those | independently at the amusement park |
| | intending to | and are provided port information by |
| | communicate | Anna. |
| 715, 716 | Users register | Greg and Iris independently register |
| | attributes and | their attributes. |
| | communication | (PORT_ATTRIBUTE_REGISTER |
| | identifier. | message)Greg uses a communication |
| | | identifier ‘bob’ and Iris uses an |
| | | identifier ‘sparkle’. |
| 717, 718 | Users can query | Greg queries for specific attributes |
| | for specific attri- | (GROUP_ATTRIBUTE_RESOLVE |
| | butes, select a | message, attribute ‘HEADLINE=’). |
| | particular person | From the returned records he selects |
| | | ‘sparkle’ |
| 719 | User initiates com- | Greg sends out a message to sparkle |
| | munication by | (Iris). |
| | sending a message | |
| | to selected person. | |
| 720 | Registration center | Registration center determines that |
| | (704) locates phone | ‘sparkle’ corresponds to Iris phone |
| | corresponding to | and delivers message to her phone. |
| | selected communi- | |
| | cation identifier | |
| | and sends message. | |

### Illustrative Embodiment of Biometric Attribute Calls

The visual identification embodiment illustrates communication based on visually identified attribute. Biometric information can also be used to establish communication as is described in the present embodiment.

In this embodiment, a photograph of the target user is used to establish communication. For description purposes, a sample scenario will be referred to in which Peter (801a) calls Hank (801b).

### System Operation

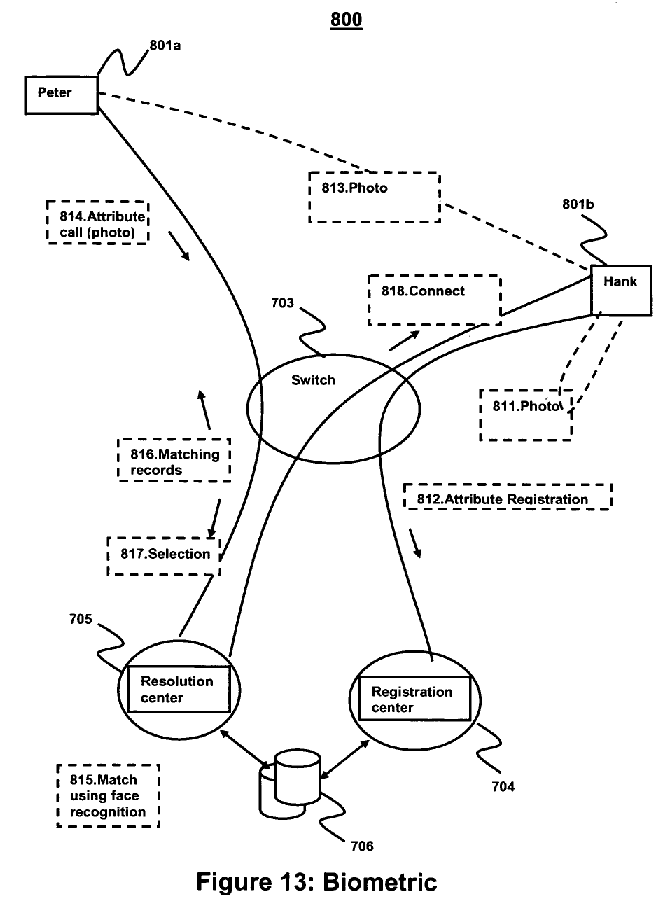

Table 13 describes one embodiment of system 800 as shown in FIG. 13. For illustration purposes, corresponding examples to each of the steps relate to a sample transaction.

The SCP 110 is configured to use a specialist biometrics information processing technology such as face recognition technology. This enables it to obtain a best match based on biometrics information.

TABLE 13

| Step | Description | Example |
|---|---|---|
| 811 | Biometric information is captured | Hank (801b) gets a photo |
| | for use as basis of communication | of himself using his |
| | | phone-with-camera |
| 812 | The information is registered | Hank sends a |
| | | ATTRIBUTE_REGISTER |
| | | message providing the |
| | | photo as a parameter. |
| | | (PHOTO=binary photo |
| | | data;) |
| 813 | Another user captures the same | Peter (801a) wants to |
| | biometric information | convey something, so he |
| | | captures a photo of the |
| | | person he wishes to speak |
| | | to (This is Hank but Peter |
| | | does not know his name) |
| | | on his phone's camera. |
| 814. | The biometric information is used | Peter makes a call to the |
| | as an attribute for establishing | Registration center (704), |
| | communication | specifying the photo he |
| | | captured as a parameter |
| | | (PHOTO=binary photo |
| | | data;) |
| 815 | Biometric information recognition | At the registration center |
| | algorithms are used to find a | face recognition |
| | match | technology is used to |
| | | identify the face |
| 816 | A set of close matches (as | Peter receives nearest |
| | determined by the algorithm) is | matches |
| | returned | |
| 817 | User makes her selection | Peter chooses the nearest |
| | | match. (This is Hank's |
| | | photo-the one registered |
| | | by Hank) |
| 818 | Connection is completed based on | Connection is established |
| | the selection | with Hank |

### Illustrative Embodiment of Neighborhood Network

People living in a residential colony refer to each other in terms of the houses they reside in. We may refer to a person by identifying the postal address at which she resides. We may also refer to a person by specifying the relative location of her house with respect to ours.

This embodiment demonstrates communication establishment based on the postal address and relative location information.

In this embodiment, a residents association controls the group information, thereby enabling such communication only within the resident community.

### System Operation

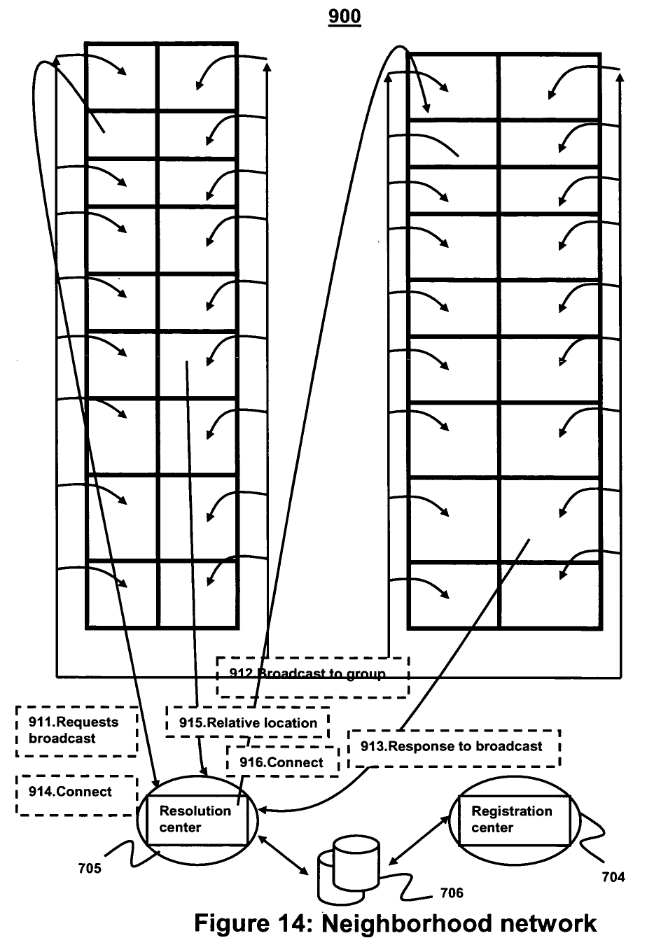

Table 14 describes one embodiment of system 900 as shown in FIG. 14. For illustration purposes, corresponding examples to each of the steps relate to a sample transaction. In this example, the neighborhood in a residential colony form a group, administered by the residents association. This allows them to communicate with ease based on the relative locations of their houses.

SCP 110 uses a Geographical Information System database that allows connections to be made in terms of relative geographical locations—as illustrated.

In this example group members register the address of their house as an attribute along with the phone number.

The following sequence assumes prior registration of attribute information.

TABLE 14

| Step | Description | Example |
|---|---|---|
| 911 | Broadcast request to | Samantha has a problem with pesky |
| | group | squirrels and wants to check if |
| | | anyone in the neighborhood can help. |
| | | She sends a broadcast request to the |
| | | group |
| | | (GRP_BROADCAST_REQ |
| | | message) |
| 912 | The resolution center | The resolution center determines all |
| | (705) broadcasts to | members belonging to the group and |
| | group | broadcasts message |
| | | (GRP_BROADCAST_MSG |
| | | message) |
| 913 | User responds to | Glen has solution to the problem so |
| | broadcast | she responds to broadcast by asking |
| | | for a connection to the sender. |
| | | ATTR_RESOLVE |
| | | HOUSE_ADDRESS=No.2,2^{nd} Street; |
| 914 | Connection is estab- | The resolution center determines the |
| | lished between user | phone number corresponding to the |
| | and broadcaster | house address and then connects to |
| | | that number |

Relative Location Query:

| | | |
|---|---|---|
| 915 | Caller specifies | Barbara needs to talk to the people |
| | destination by | living on the North corner, opposite |
| | providing relative | side of the street. |
| | location | She sends a |
| | | ATTRIBUTE_RESOLVE message |
| | | specifying |
| | | HOUSE_LOCATION=”Opposite- |
| | | row North- corner” |
| 916 | The resolution center | The resolution center uses the |
| | locates the phone | information to determine the house |
| | number corresponding | address by querying a GIS system. |
| | to the specified | From the house address the |
| | location and completes | corresponding phone number is |
| | connection | retrieved and the connection is |
| | | completed. |

### Group Owned Communication Identifiers

Since people communicate based on attributes, the communication identity just identifies the attributes.

In this embodiment the group controls the communication identifiers used within the group. Members attach their profile to the communication identifier and then communicate. This achieves complete separation of communication identity from attributes. This also avoids users having to come up with suitable identifiers even for short conversations.

### System Operation

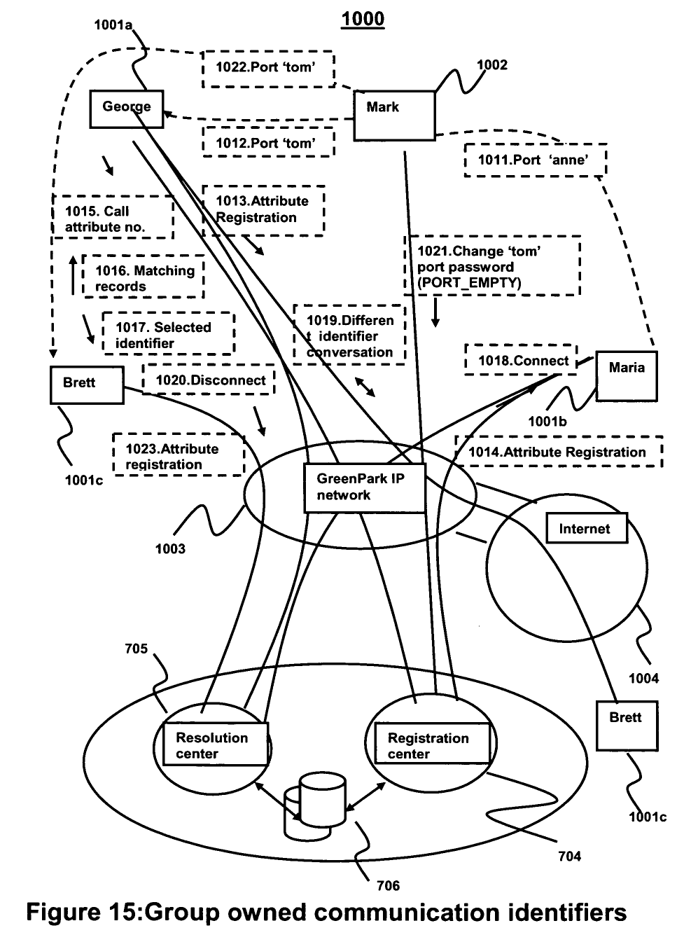

Table 15 describes one embodiment of system 1000 as shown in FIG. 15. For illustration purposes, corresponding examples to each of the steps relate to a sample transaction.

This scenario illustrates the concept of group owned communication identifiers. Groups create a set of communication identifiers that are provided to users for temporary usage. This scenario also illustrates communication on an IP network. A park providing wireless IP network using technology such as WiFi is used for illustration. Also demonstrated is the use of multiple identities simultaneously.

The same network address is used for registration and resolution. Messages are routed based on its type to the registration or resolution servers.

TABLE 15

| Step | Description | Example |
|---|---|---|
| 1011, | Communication | Maria (1001b) enters the park |
| 1012 | identifiers are | and is provided a username |
| | provided by group | and password (‘anne’, 3344). |
| | administrator | Similarly George (1001a) |
| | (1002) | enters the park sometime later |
| | | and is provided a username |
| | | and password.(‘tom’, 1122) |
| 1013, | Users attach their | Maria sends a |
| 1014 | attributes to the | PORT_ATTRIBUTE_REGISTER |
| | communication | message: |
| | identifier provi- | to the Greenpark group ad- |
| | ded. | dress: Greenpark.com |
| | | Port_Attribute_register |
| | | Message parameters: |
| | | GROUP_NAME=GreenPark; |
| | | PORT_NAME=anne;PASSWORD=1122; |
| | | FOR_SALE=sparingly used laptop |
| | | for sale; |
| | | George sends his own attribute |
| | | registration |
| | | GROUP_NAME=GreenPark; |
| | | PORT_NAME=tom;PASSWORD=3344; |
| | | JUST_ARRIVED=new to town and |
| | | setting up apartment; |
| 1015. | User query group | George decides to browse group. |
| | for any informa- | He sends out a ‘FOR_SALE’ |
| | tion of interest | query: |
| | | Group_attribute_resolve |
| | | GROUP_NAME=GreenPark; |
| | | PORT_NAME=tom; PASSWORD=3344; |
| | | FOR_SALE=; |
| 1016 | User gets data- | George gets a list of records |
| | base records | with the FOR_SALE attribute. |
| | selected by query | Maria's information is also |
| | | listed with her communication |
| | | identifier ‘anne’. |
| 1017 | User selects a | George decides to communicate |
| | choice | with ‘Anne’ about the laptop. |
| | | George selects Anne's record |
| | | and sends a message to the |
| | | registration center (704) |
| | | indicating the choice. |
| 1018 | The resolution | The registration center |
| | center (705) maps | establishes a connection |
| | the choice to the | between the communication |
| | appropriate com- | identities ‘tom’ and ‘anne’. |
| | munication iden- | |
| | tifier and sets | |
| | up a conversation | |
| | with that identi- | |
| | fier through the | |
| | registration | |
| | center | |
| 1019 | User can communi- | George gets a call on his |
| | cate on another | regular IP phone identifier |
| | IP based identi- | from his colleague and attends |
| | fier if device | to it |
| | permits. | (Momentarily suspending the |
| | | conversation with Anne) |
| 1020 | User completes | George completes conversation |
| | original conver- | with Anne and moves out of |
| | sation and moves | group, signaling to the |
| | out of group | administrator. |
| | The administrator | The administrator realizes |
| | realizes port | Port ‘tom’ is free for use by |
| | used by user is | someone else. |
| | now free to be | |
| | used again by | |
| | someone else. | |
| 1021 | Group administra- | Mark sends a PORT_EMPTY |
| | tor changes port | message |
| | password | |
| 1022 | Port is allocated | Brett (1001c) enters the park |
| | to another user | and is provided a username and |
| | | password |
| 1023 | New user attaches | Brett registers his attributes |
| | his/her profile | by sending a PORT_ATTRIBUTE_{—} |
| | to communication | REGISTER message |
| | identifier | |

### Multiple Profiles, Multiple Groups

People generally like to separate different aspects of their life. In this context there may be attributes relating to their personal life and other attributes relating to their professional life.

They may thus want to communicate based on these different aspects using different communication identities.

This embodiment demonstrates communication on multiple communication identities based on multiple profiles.

### System Operation

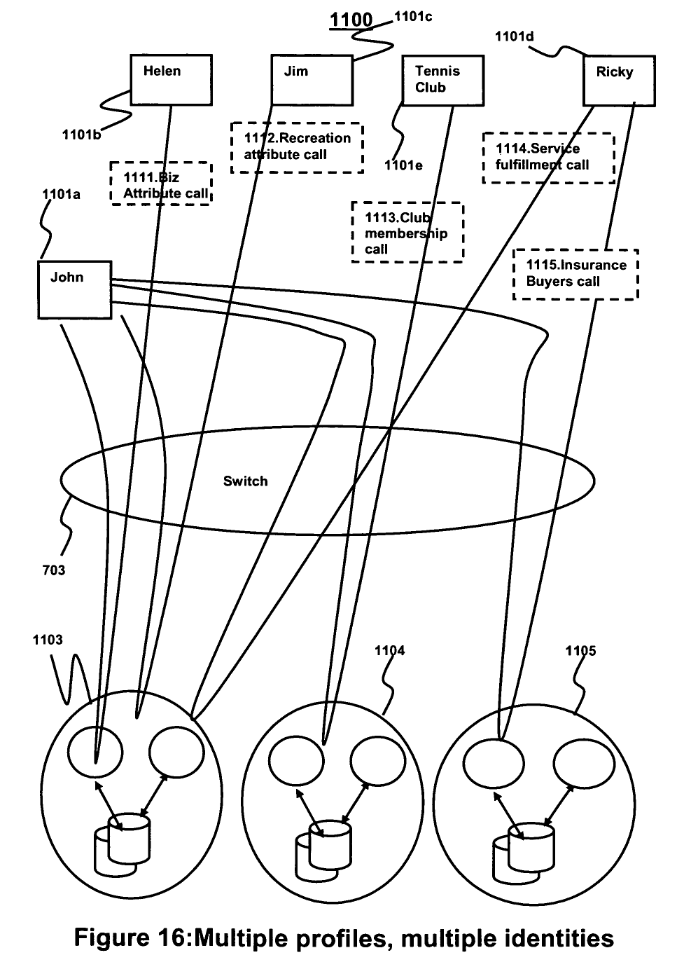

Table 16 describes one embodiment of system 1100 as shown in FIG. 16. For illustration purposes, corresponding examples to each of the steps relate to a sample transaction.

Multiple attributes corresponding to different facets can be registered in one or more communication identifiers.

In this example, John enters a shopping mall and registers three attributes under two communication identifiers. The first communication identity ‘John’ and the attribute BIZ: ‘manage mid sized portfolios as a stock analyst’; SERVICE_NEEDED: ‘planning to buy car insurance’. The second communication identity ‘Mitch’ and the attribute SPORTS: ‘tennis, baseball’;

The details of the exact message parameters are omitted here to keep the explanation simple. Message parameter details are shown in other scenarios described in this document. Similarly, creating a group, obtaining port information and other administrative details are omitted.

TABLE 16

| Step | Description | Example |
|---|---|---|
| 1111 | Users can communicate based on any | Helen (1101b) sees |
| | attribute of their choice | potential business |
| | | opportunity in talking to |
| | | John and calls him based |
| | | on his communication |
| | | identifier ‘John’. |
| 1112 | Users can communicate based on any | Jim (1101c) is enthused |
| | attribute of their choice | to find another person |
| | | interested in baseball and |
| | | calls ‘Mitch’(John) on |
| | | have a friendly chat |
| 1113 | Communication identifiers created in | John is a member of |
| | other groups are also active | tennis club (1101e) and |
| | | as part of his membership |
| | | he has a communication |
| | | identifier. |
| | | This avoids John having |
| | | to disclose his number to |
| | | club officials. |
| | | John receives a call from |
| | | the club notifying him |
| | | that they have found a |
| | | partner for his scheduled |
| | | game. |
| 1114 | Users can communicate based on any | Ricky (1101d) is a car |
| | attribute of their choice. | insurance salesman |
| | Other identifiers can be provided for | window shopping at the |
| | future conversations, if so desired. | same shopping mall. |
| | | Ricky calls |
| | | communication identifier |
| | | ‘John’ (John) to explore |
| | | matters. |
| | | John likes the |
| | | conversation and |
| | | provides Ricky with |
| | | another identifier of his, |
| | | which is on the |
| | | ‘InsuranceBuyers’ group. |
| | | This is because his |
| | | current identifier will be |
| | | discarded as soon as he |
| | | leaves the restaurant |
| 1115 | Identifiers on multiple groups can be | As scheduled, two days |
| | active | later Ricky calls up John |
| | | on his ‘InsuranceGroup’ |
| | | communication identifier |

### No-Propagation Group

Network identities such as phone numbers can be a source of nuisance if they reach the wrong hands. In many situations, one person may be willing to divulge their phone number while the other wants to communicate but without risking revealing her phone number.

In a typical salesperson-customer transaction, the salesperson may be using a business phone and hence too happy to divulge her phone number, whereas the customer may needs her phone number to be private, but she still has the need to be able to communicate with the salesperson.

If the need for communication between the two people lasts for a few months, during that period even the temporary identifier used for communication can be spammed.

In this embodiment, maintaining a list of permitted network identities that can use that communication identifier for establishing communication protects the communication identifier.

In a way, the communication identifier does not propagate when passed on from one person to other: those not in the permitted list cannot use the communication identifier to establish communication.

### System Operation

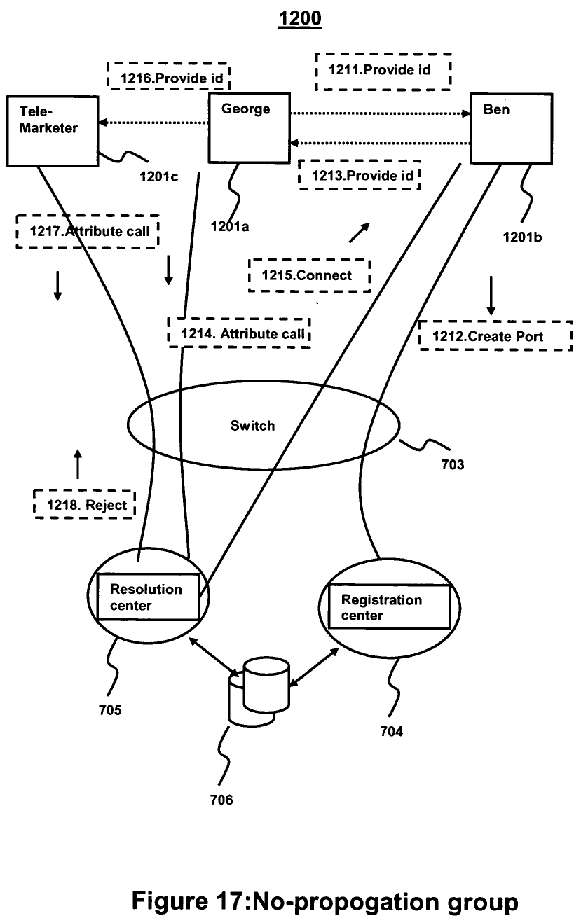

Table 17 describes one embodiment of system 1200 as shown in FIG. 17. For illustration purposes, corresponding examples to each of the steps relate to a sample transaction. In this example, an amusement park decides to avail of the “spot grouping” service. The management of the park identifies Anna to be the group administrator.

TABLE 17

| Step | Description | Example |
|---|---|---|
| 1211 | Person needing to | George (1201a) wants to |
| | communicate with an | be able to communicate |
| | acquaintance she | with Ben (1201b) but |
| | does not know very | wants to protect himself |
| | well, picks up the | from spam. George gets |
| | other persons | Ben's phone number. |
| | number. | |
| 1212 | She sends a port | George sends a PORT_CREATE |
| | create message. | message to the registration |
| | This creates an | center (704).The message |
| | identifier for this | parameters are: |
| | person on this | GROUP_NAME=NoPropagation; |
| | group and also | PORT_NAME=geo; |
| | specifies only | PASSWORD=5321; |
| | phone numbers | PERMITTED_PHONE_NUMBER= |
| | mentioned in this | 5344562244; |
| | message should be | This creates an identi- |
| | allowed to make | fier for him on this |
| | calls. | group and also specifies |
| | | Ben can call on this |
| | | identifier. |
| 1213 | The other person is | George provides Ben his |
| | provided the newly | new communication iden- |
| | created communica- | tifier. |
| | tion identifier | |
| 1214, | The acquaintance is | Ben can keep in touch |
| 1215 | able to call and | with George on the newly |
| | communicate on this | created identifier |
| | identifier by making | |
| | ‘attribute calls’ | |
| 1216 | Acquaintance pro- | Ben provides the identi- |
| | vides identifier to | fier to a telemarketing |
| | someone else, say a | company |
| | telemarketing | |
| | company (1201c) | |
| 1217 | Telemarketing | Telemarketing company |
| | company attempts | attempts connecting with |
| | calling on the | George on the specified |
| | specified iden- | identifier |
| | tifier. | |
| 1218 | The resolution | |
| | center (705) re- | |
| | jects the call | |
| | since the telemar- | |
| | keting company is | |
| | not in the list of | |
| | permitted callers. | |

### Illustrative Embodiment of Infrared Based Registration

The requirement of a group administrator to interact with every new member to pass on port information can be eliminated by using suitable equipment to provide the same functionality.

One such embodiment is the use of infrared communication to provide port information for new members. This is demonstrated in the current embodiment.

Since infra red communication requires an obstacle free straight path between communicating devices, it can be used for detecting presence of the device in vicinity. This is useful where group membership is based on physical presence of a person at some physical location. (Example: Customer in the restaurant, customer at a amusement park).

In this embodiment, the Registration Center (704) is equipped with infrared communication capability and performs tasks on behalf of the group administrator. A functional equivalent is to have a mobile phone equipped with infrared capability and under control of the administrator perform the tasks on behalf of the administrator. The current functional description is only used to demonstrate the system functioning without the need for a human administrator to interact with every new member.

This embodiment also demonstrates minimizing manual operations required of members in participating in this system.

### System Operation

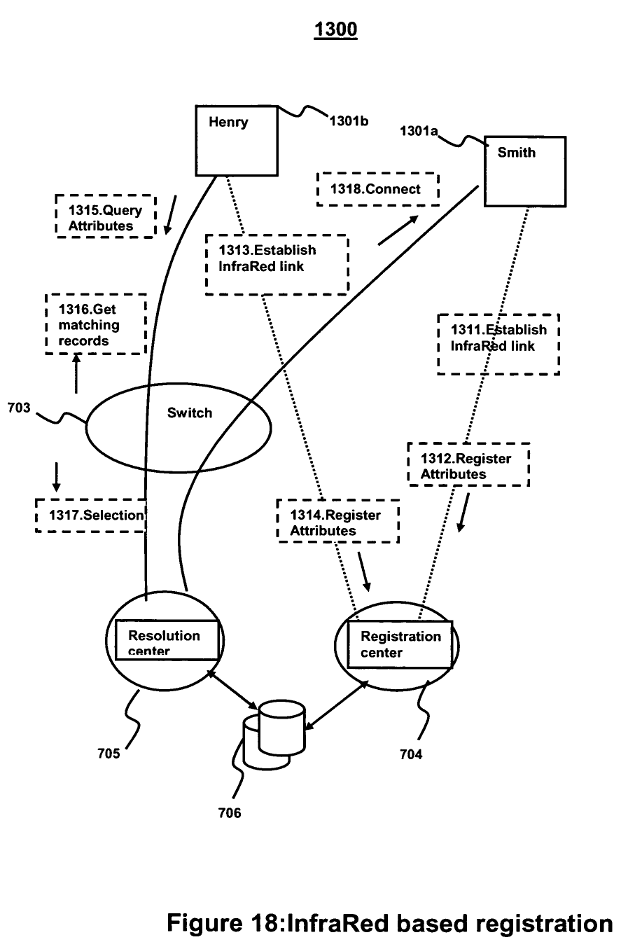

Table 18 describes one embodiment of system 1300 as shown in FIG. 18. For illustration purposes, corresponding examples to each of the steps relate to a sample transaction.

This scenario shows the use of InfraRed communication that eliminates the need for an administrator. The devices used by the users are assumed to have infrared capability. Similarly the registration center has a infrared interface.

Scenario depicts Smith and Henry establishing communication at a convention center.

TABLE 18

| Step | Description | Example |
|---|---|---|
| 1311 | User established | Smith (1301a) enters the |
| | infrared link with | convention center and |
| | registration center (704) | established a Infrared |
| | | link with the registration |
| | | center |
| 1312 | User transfers phone | Smith transfers his |
| | number, attributes, | phone number, |
| | Communication identity | attributes and |
| | | Communication identity |
| 1313, 1314 | Other users can register | Henry (1301b) enters |
| | in a similar manner. | the convention center |
| | | and makes a similar |
| | | registration |
| 1315 | User can query for | Henry queries for |
| | attributes | specific attributes |

The rest of the steps are as outlined in other scenarios.

### Illustrative Embodiment of Device Based Resolution Using Bluetooth

Some people may prefer to maintain their attribute information on their own personal device.

This embodiment demonstrates a system where the attributes are stored on the personal device of the person. After two people discover each other they can continue to communicate over a different communication channel.

This scenario shows the usage of Bluetooth to establish connection, thereby eliminating the need for a common resolution or registration center.

### System Operation

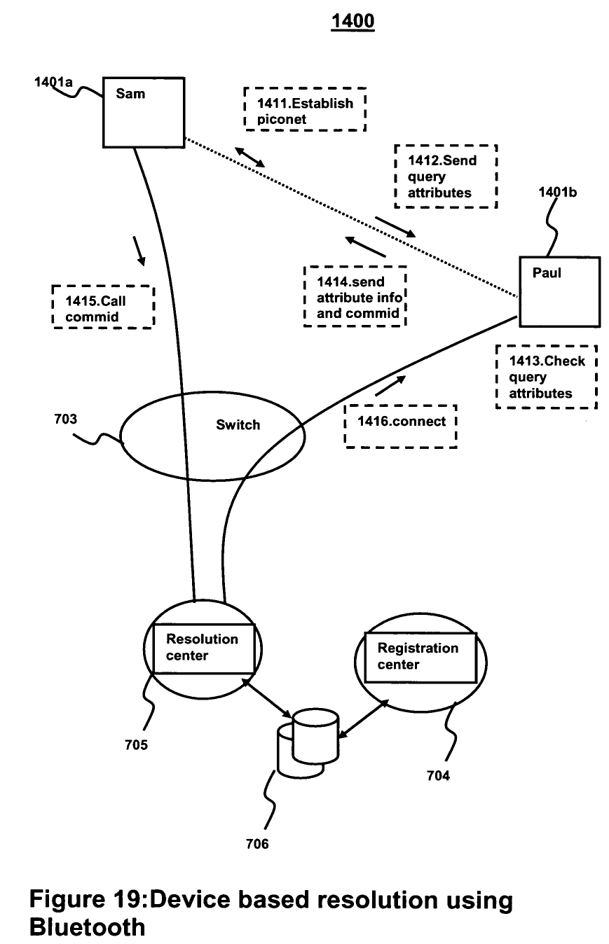

Table 19 describes one embodiment of system 1400 as shown in FIG. 19. For illustration purposes, corresponding examples to each of the steps relate to a sample transaction.

Sam (1401a) and Paul (1401b) have Bluetooth devices that alternatively switch between responding to inquiries and issuing inquiries. Paul is assumed to have a Communication identity ‘pl’ which can be resolved at the group number 6004346788.

TABLE 19

| Step | Description | Example |
|---|---|---|
| 1411 | Users form a piconet | Sam happens to walk by |
| | whenever they are in | Paul in the shopping |
| | range | mall. |
| | | Sam's device issues an |
| | | inquiry to which Paul's |
| | | device responds. The |
| | | devices complete the |
| | | Bluetooth handshake |
| | | and form a piconet with |
| | | Sam's device being the |
| | | master and Paul's |
| | | device being the slave |
| 1412 | Query Attributes are | Sam's device passes the |
| | passed from one device | query attributes to |
| | (initiator) to another | Paul's device |
| | (recipient) | |
| 1413 | The recipient checks the | Paul's device checks the |
| | query attributes against | query attributes against |
| | its own attribute | its own attribute |
| | information and detects | information |
| | a match | And detects a match |
| 1414 | The recipient responds | Paul's device responds |
| | with its attribute | with Paul's attribute |
| | information and | information and |
| | Communication identity | Communication identity |
| 1415 | Piconet is dismantled | Sam checks Paul's |
| | and | attributes and then |
| | Initiator connects with | connects with Paul on |
| | recipient over | his Communication |
| | Communication identity | identity (resolved at the |
| | using some othe | specified group phone |
| | communication channel | number) |

In this scenario the piconet is used just to detect attribute match. The actual communication is not done over the piconet, just so that the piconet can be broken and the frequencies released.

Changing the inquiry packet to hold attribute information can enable piconets to be established only if attributes match. (The attribute matching then takes place at inquiry stage rather than after forming piconet).

### Illustrative Embodiment of Vehicle Communication

We can identify someone we wish to communicate with in terms of the vehicle they are associated with. They could be in the vehicle or they could have just parked the vehicle and walked away—but we could be able to associate them with the vehicle.

Vehicle numbers may themselves be used as attributes to establish communication. Alternatively, a Communication identity can be displayed on the vehicle number plate. The second scheme offers more flexibility in terms of changing the identifier at will while retaining the same vehicle number.

This embodiment demonstrates communication establishment based on a visually displayed identifier located on a vehicle.

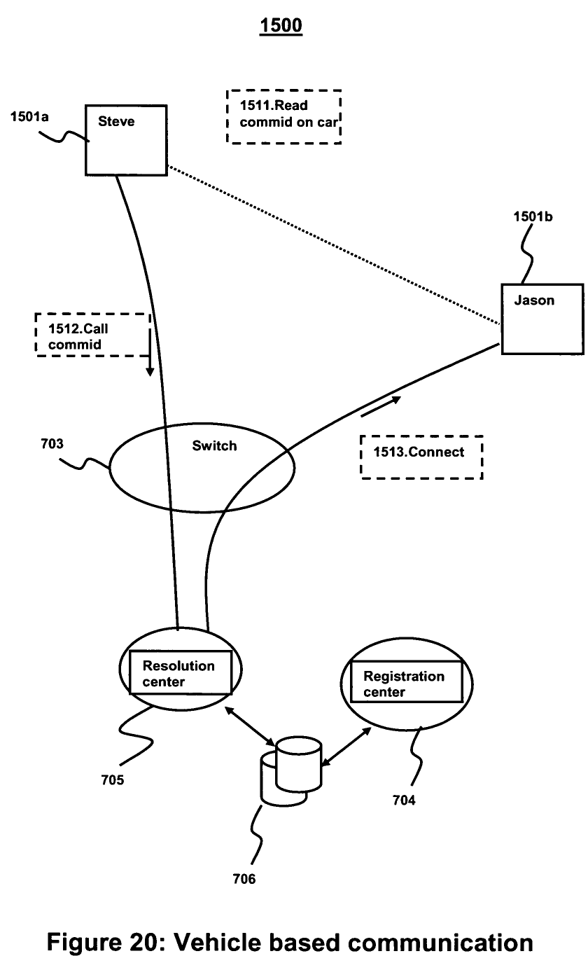

Table 20 describes one embodiment of system 1500 as shown in FIG. 20. For illustration purposes, corresponding examples to each of the steps relate to a sample transaction. Jason (1501b) has a communication identity ‘js’ which can be resolved at group phone number 6005224567. He displays this communication identity as ‘js-6005224567’ on his vehicle number plate. This is a temporary communication identity and can be changed at will, so he has no real privacy issues. Steve (1501a) is new to town and driving on the same road behind Jason. He decides to ask the person in the car in front for a restaurant recommendation.

TABLE 20

| Step | Description | Example |
|---|---|---|
| 1511 | User spots | Steve spots the |
| | Communication identity | Communication identity |
| | on the car | on Jason's car. |
| 1512 | User connects via | Steve connects with |
| | Communication identity | Jason using the |
| | | Communication identity |
| | | displayed on the car. |

### Illustrative Embodiment of Built-In Directory

Attribute based communication can be used to make connections based on services required, instead of calling up businesses just based on their phone numbers and then trying to determine their capabilities.

In this embodiment, the resolution center is equipped with information such as available in an online yellow pages directory. The difference is that the connection can be established in one operation.

The other major difference is that because there is no need to reveal a network identity, those using personal phones but capable of offering personalized services such as mowing the lawn, odd-jobs can now advertise their services without loss of privacy. In the absence of such privacy protection these services would not be advertised.

### System Operation

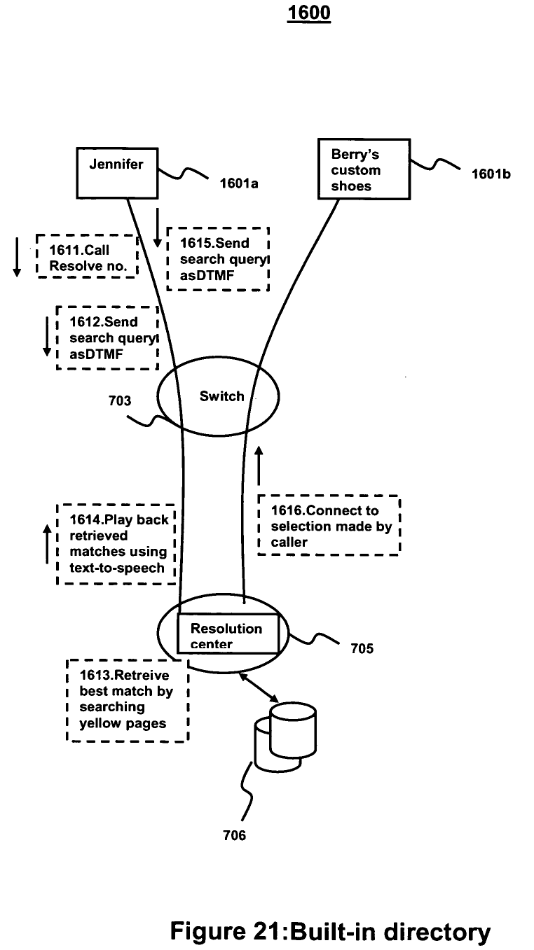

Table 21 describes one embodiment of system 1600 as shown in FIG. 21. For illustration purposes, corresponding examples to each of the steps relate to a sample transaction.

TABLE 21

| Step | Description | Example |
|---|---|---|
| 1611 | Attribute call: | Jennifer (1601a) decides to locate a |
| | Caller dials designated | nearby custom shoe maker. She dials |
| | phone number. | the Query phone number |
| | (This number can be | (6006665555). |
| | memorized in the phone | The call connects to the Resolution |
| | and caller may not be | Center (705) |
| | aware of the number) | |
| 1612 | Attribute call | Jennifer sends a |
| | Caller sends a | Group_attribute_resolve message to |
| | Group_attribute_resolve | the query phone number |
| | message specifying | (6006665555). |
| | attributes and desired | The message parameters are: |
| | values (through DTMF | GROUP_NAME=Query; |
| | tones) | QUERY= custom AND shoe AND |
| | The best match is | (maker OR designer) |
| | selected as the target of | This message is sent as DTMF tones. |
| | the call. | The telephony card in the Resolution |
| | | center detects the tones and converts |
| | | them to digital representations for |
| | | further processing. |
| | | (In this example a Boolean query |
| | | commonly supported by internet |
| | | search engines is shown) |
| 1613 | These attributes are used | The application running at the |
| | to retrieve from the | resolution center picks up this digital |
| | yellow pages database | data and queries the yellow pages |
| | businesses matching | database for matching attributes and |
| | fully/partially attributes | associated phone number. |
| | specified by the caller. | |
| 1614 | The retrieved entries are | In the current scenario, ‘Berry |
| | played back as a voice | custom shoes’, (1601b) ‘Liberty |
| | menu using text-to- | footwear’ are the matching entries |
| | speech | retrieved. |
| | | These are played back to caller as |
| | | menu selections 1 and 2 respectively |
| 1615 | Caller makes a selection | Jennifer selects item 1 (i.e. Berry |
| | on the menu | custom shoes) |
| 1616 | Through the telephony | On another line a connection is made |
| | board a call is made to | to ‘Berry custom shoes’ and a |
| | the selected phone on | connection is established between |
| | another line | Jennifer and the custom shoe maker |

The implementation of these techniques as well as similar adaptations falls within the scope of this invention.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

1. An attribute based communication system for establishing communication channels between an originating user and a target user, the system comprising:
an access switch associated with an originating user communication unit, the access switch configured to receive a communication request message from the originating user communication unit and determining a network identifier of a target communication unit based on the communication request message, the communication request message including an identification attribute of the target user;
a registration database communicatively coupled with the switch via message routing equipment, the registration database configured to store a target user record indicating a correlation between the network identifier of the target user communication unit and one or more associated identification attributes of the target user; and
a registration center communicatively coupled with the access switch and the registration database and configured to receive record editing messages from the target user to modify the associated identification attributes in the target user record.

2. The system of claim 1, wherein the originating and target user communication units are wireless telephones.

3. The system of claim 1, wherein the messages are short messaging service messages.

4. The system of claim 1, wherein the messages are voice data associated with a telephone call.

5. The system of claim 1, wherein the target user identification attribute is biometric information

6. The system of claim 1, wherein the target user identification attribute is postal address

7. The system of claim 1, wherein the target user identification attribute is a relative location specification

8. The system of claim 1, wherein the target user attribute is a visually displayed identifier placed on a vehicle associated with the target user.

9. The system of claim 1, wherein the target user attribute is the vehicle number of a vehicle associated with the target user.

10. The system of claim 1, further comprising a signal connection point communicatively coupled to the access switch and configured to provide the network identifier of the target communication unit to the switch in response to a switch target network identifier determination request.

11. The system of claim 10, wherein the signal connection point is further communicatively coupled to the registration database for retrieving the network identifier of the target communication unit based on the one or more associated identification attributes of the target user.

12. The system of claim 11, wherein the target user identification attribute is biometric information

13. The system of claim 11, wherein the target user identification attribute is postal address

14. The system of claim 11, wherein the target user identification attribute is a relative location specification

15. The system of claim 11, wherein the target user attribute is a visually displayed identifier placed on a vehicle associated with the target user.

16. The system of claim 11, wherein the target user attribute is a the vehicle number of a vehicle associated with the target user.

17. The system of claim 3, wherein the communication request message includes a virtual phone number.

18. A computer based method for establishing communication channels between an originating user and a target user, the method comprising:
receiving a record registration message, the record registration message including one or more target user attributes and a network identifier for a target user communication unit;
storing in a target user record the one or more target user attributes and the network identifier for the target user communication unit;
receiving a communication request message from an originating user, the communication request message including an attribute of the target user;
determining the network identifier of the target user communication unit by relating the communication request message with the target user record to identify an attribute match;
establishing a communication channel between the originating user and the target user at least in part by routing communications from the originating user to the network identifier of the target user communication unit.

19. The method of claim 18, wherein the attribute includes an attribute name and an attribute value.

20. The method of claim 18, wherein the target user identification attribute is biometrics information

21. The method of claim 18, wherein the target user identification attribute is postal address

22. The method of claim 18, wherein the target user identification attribute is a relative location specification

23. The method of claim 18, wherein the target user attribute is a visually displayed identifier placed on a vehicle associated with the target user.

24. The method of claim 18, wherein the target user attribute is the vehicle number of a vehicle associated with the target user.

25. The method of claim 18, wherein the communication units are telephones and the network identifiers are telephone numbers.

26. The method of claim 25, wherein the communication units are wireless telephones and the messages are short messaging system messages.

27. The method of claim 18, wherein the attribute further includes a time period.

28. The method of claim 18, wherein the record registration message includes plurality of target user attributes, and further wherein the time period in the in each of the plurality of target user attributes indicates which attribute values are available for relating the communication request message with the target user record during a particular time.

29. The method of claim 18, wherein the communications from the originating user include voice data associated with a telephone call.

30. The method of claim 29, wherein the target user identification attribute is biometrics information

31. The method of claim 29, wherein the target user identification attribute is postal address

32. The method of claim 29, wherein the target user identification attribute is a relative location specification

33. The method of claim 29, wherein the target user attribute is a visually displayed identifier placed on a vehicle associated with the target user.

34. The method of claim 29, wherein the target user attribute is the vehicle number of a vehicle associated with the target user.

35. An attribute based communication system for establishing communication channels between an originating user and a target user, the system comprising:
an access switch associated with an originating user communication unit, the access switch configured to receive a communication request message from the originating user communication unit and determining a network identifier of a target communication unit based on:
an identification attribute of the target user included in the communication request message and the network identifier of the originating user communication unit verified to be present in the list
of permitted network identities maintained in the target user record;
a registration database communicatively coupled with the switch via message routing equipment, the registration database configured to store a target user record, the user record including:
a correlation between the network identifier of the target user communication unit and one or more associated identification attributes of the target user and
a list of network identities permitted to communicate based on the identification attributes of the target user; and
a registration center communicatively coupled with the access switch and the registration database and configured to receive record editing messages from the target user to modify the associated identification attributes in the target user record.

36. An attribute based communication system for establishing communication on a second communication channel based on a first communication channel established between an originating user and a target user, the system comprising:
Originating user communication unit and target user communication unit, both capable of communication over two different communication channels, a first communication channel and a second communication channel;
a First registration database located in the target communication unit, the database configured to store a target user record indicating correlation between identification attributes associated with the first communication channel and another identification attribute associated with the second communication channel
the target user communication unit, configured to receive a attribute discovery message from the originating user communication unit on the first communication channel and responding with target user identification attribute corresponding to communication on the second communication channel, by correlating the identification attribute included in the attribute discovery message with the target user record stored in the registration database of the target user communication unit;
an access switch associated with the originating user communication unit in establishing the second communication channel, the access switch configured to receive a communication request message from the Originating User Communication Unit and determining network identity of target user communication unit based on communication request message, the communication request message including identification attribute of target user;
a second registration database coupled with an access switch, the database configured to store a target user record indicating a correlation between the network identifier of the target user communication unit and associated identification attribute of the target user; and
a registration center communicatively coupled with the access switch and the registration database and configured to receive record editing messages from the target user to modify the associated identification attributes in the target user record.

37. The system of claim 36, wherein the first communication channel uses Bluetooth technology

38. The system of claim 36, wherein the second communications channel is wireless telephone technology.

39. The system of claim 36, wherein the first communication channel uses bluetooth technology and the second communication channel is used to communicate voice data.

40. An attribute based communication system for establishing communication channels between an originating user and a target user, the users being members of a group controlled by an administrator, the system comprising:
an access switch associated with an originating user communication unit, the access switch configured to receive a communication request message from the originating user communication unit and determining a network identifier of a target communication unit based on the communication request message, the communication request message including an identification attribute of the target user, a group identifier identifying a set of network identities and a permission key of the originating user provided by a group administrator providing permission to communicate within the group;
a registration database communicatively coupled with the switch via message routing equipment, the registration database configured to store a target user record specifying a group identifier identifying a set of network identities and associated identification attributes to which this record belongs, a permission key obtained from the group administrator providing permission to communicate within the group, the network identifier of the target user communication unit and one or more associated identification attributes of the target user;
a registration center communicatively coupled with the access switch and the registration database and configured to receive record editing messages from the target user to modify the associated identification attributes in the target user record; and
a group administrator communicatively coupled with the registration database, creating permission keys that allow users to register identification attributes or search for other users based on identification attributes and deleting permission keys thereby removing associated user from registering or searching for identification attributes in user records identified by the group identifier.

41. The system of claim 40, wherein the administrator specifies user presence in a physical location controlled by the administrator as eligibility for group membership.

42. The system of claim 40, wherein the permission key is associated with a validity time period.

43. The system of claim 40, wherein the administrator provides permission key to user on entry into a physical location

44. The system of claim 40, where the communication is voice data.

45. The system of claim 40, where the communication is short message service.

46. The system of claim 40, where the communication is over the internet protocol network.

47. The system of claim 40, wherein further user membership to the group is terminated by the administrator when the user leaves the premises

48. The system of claim 40, wherein further user membership to the group is based on residence in a physical location governed by the group administrator

49. The system of claim 40, wherein further successful establishment of short range communication link between member communication unit and registration center is used to detect user presence in physical location and thereby provide membership to the group

50. The system of claim 40, wherein the target user identification attribute is biometric information

51. The system of claim 40, wherein the target user identification attribute is postal address

52. The system of claim 40, wherein the target user identification attribute is a relative location specification

53. The system of claim 40, wherein the target user attribute is a visually displayed identifier placed on a vehicle associated with the target user.

54. The system of claim 40, wherein the target user attribute is the vehicle number of a vehicle associated with the target user.

55. The system of claim 40, wherein the communication units are wireless telephones.

56. The system of claim 40, wherein the network identifiers are telephone numbers associated with a telephone network.

57. The system of claim 40, wherein the messages are short messaging system messages.

58. The system of claim 40, wherein further the permission key identifies the target user for communication within the group

59. The system of claim 40, wherein the group provider is a commercial establishment.

60. The system of claim 40, wherein the target user attribute is a visually displayed identifier

61. The system of claim 40, wherein the target user attribute is a visually displayed identifier placed on a vehicle associated with the target user.

62. The system of claim 40, wherein the target user attribute is the vehicle number of a vehicle associated with the target user.
